(19) United States
(12) Patent Application Publication
(10) Pub. No.: US 2012/0151404 A1
(43) Pub. Date: Jun. 14, 2012

(54) REPURPOSING TOOLBAR INPUT AREAS

(75) Inventors: Shovon Nazmus, Redmond, WA (US); Felipe (Phil) Luis Naranjo, Seattle, WA (US)

(73) Assignee: MICROSOFT CORPORATION, REDMOND, WA (US)

(21) Appl. No.: 12/963,718

(22) Filed: Dec. 9, 2010

(51) Int. Cl. G06F 3/048

(52) U.S. Cl. 715/780

(57) ABSTRACT

Methods and systems for repurposing toolbar input areas are provided. Input areas of toolbars may be repurposed such that the input area is linked to one or more applications. An input area may be linked to one or more applications upon receiving a linking mode selection from a user. An input area may also be linked to one or more applications upon receiving a user input including a trigger that identifies an application. Such linking causes results associated with the user input to be filtered by the one or more applications associated with the input area. Input areas may also display results filtered by one or more applications without being directly linked to the applications.

### BACKGROUND

Toolbars are common features of user interfaces today. A toolbar, as used herein, refers generally to a component of a graphical user interface (GUI) that includes onscreen selectable elements such as menus, buttons, icons, or other input or output elements. A toolbar may include an input area for inputting, for example, search queries. The input area is usually a gateway to locate information from the Internet. Users are commonly confronted with a desire to search for information within applications but are required to open the application first. Even then, the application must be searched from within. Users do not have a toolbar input area available to search desired applications or to search both the Internet and desired applications.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, repurposing an input area of a toolbar. A toolbar, as used herein, refers generally to a component of a graphical user interface (GUI) that includes onscreen selectable elements such as menus, buttons, icons, or other input or output elements. An input area, as used herein, refers generally to an area configured to receive an input. In embodiments, the input area is located within a toolbar. The input area may be repurposed such that it is linked with at least one application. Accordingly, inputs received in the input area may be associated with results that are filtered by the at least one application linked to the input area.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a block diagram of an exemplary computing system in which embodiments of the invention may be employed;

FIG. 3 is a first exemplary method 300 for repurposing toolbar input areas, in accordance with an embodiment of the present invention;

FIG. 4 is a second exemplary method 400 for repurposing toolbar input areas, in accordance with embodiments of the present invention; and

FIG. 5 is a flow diagram showing a third exemplary method 500 for repurposing toolbar input areas, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, utilizing tags to transfer data. Tags may be generated for presentation on a display device of a first computing device. The tags may include tag content, which is content identified as desirable to communicate to a second computing device. The tag content may include information relevant to actions to be performed by the second computing device. The tags are generated such that, upon selection by the second computing device, the tag content is communicated to the second computing device. Accordingly, the actual content is transferred from the tag displayed on the display device of the computing device to the second computing device.

Accordingly, one embodiment of the present invention is directed to one or more computer-readable storage media storing computer-useable instructions that, when used by one or more computing devices, cause the one or more computing devices to perform a method for repurposing toolbar input areas. The method comprises receiving a user input in an input area. One or more applications that are running at the time the user input is received are identified. At least one result that is related to one of the one or more applications currently running is displayed to a user.

Another embodiment of the present invention is directed to one or more computer-readable storage media storing computer-useable instructions that, when used by one or more computing devices, cause the one or more computing devices to perform a method for repurposing toolbar input areas. The method comprises receiving a first user selection of an application-launch indicator that launches a corresponding application. A second user selection of a mode indicator is received that indicates one of a first mode that links an input area with the application or a second mode that separates the application and the input area. A user input is received within the input area. One or more results are then displayed to the user in accordance with the selected mode.

In yet another embodiment, the present invention is directed to one or more computer-readable storage media storing computer-useable instructions that, when used by one or more computing devices, cause the one or more computing devices to perform a method for repurposing toolbar input areas. A user input is received within an input area. The user input includes a trigger associated with at least one application. The at least one application associated with the trigger is identified. The at least one application associated with the trigger is then searched for the user input. A plurality of results are filtered by the at least one application associated with the trigger and the filtered results are displayed.

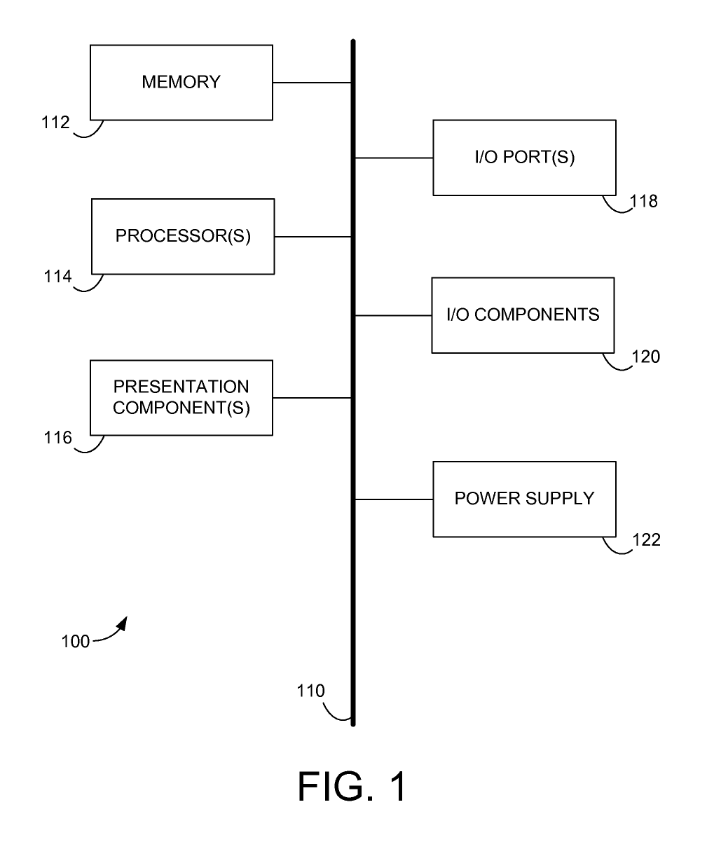

Having briefly described an overview of embodiments of the present invention, an exemplary operating environment in which embodiments of the present invention may be implemented is described below in order to provide a general context for various aspects of the present invention. Referring initially to FIG. 1 in particular, a block diagram illustrating an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” and the like, as all are contemplated within the scope of FIG. 1 and reference to “computing device.”

The computing device 100 typically includes a variety of computer-readable media. Computer-readable media can be any available media capable of being accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O component(s) 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O component(s) 120, some of which may be built in. Illustrative components include a microphone, joystick, game pad, satellite dish, scanner, printer, wireless device, and the like.

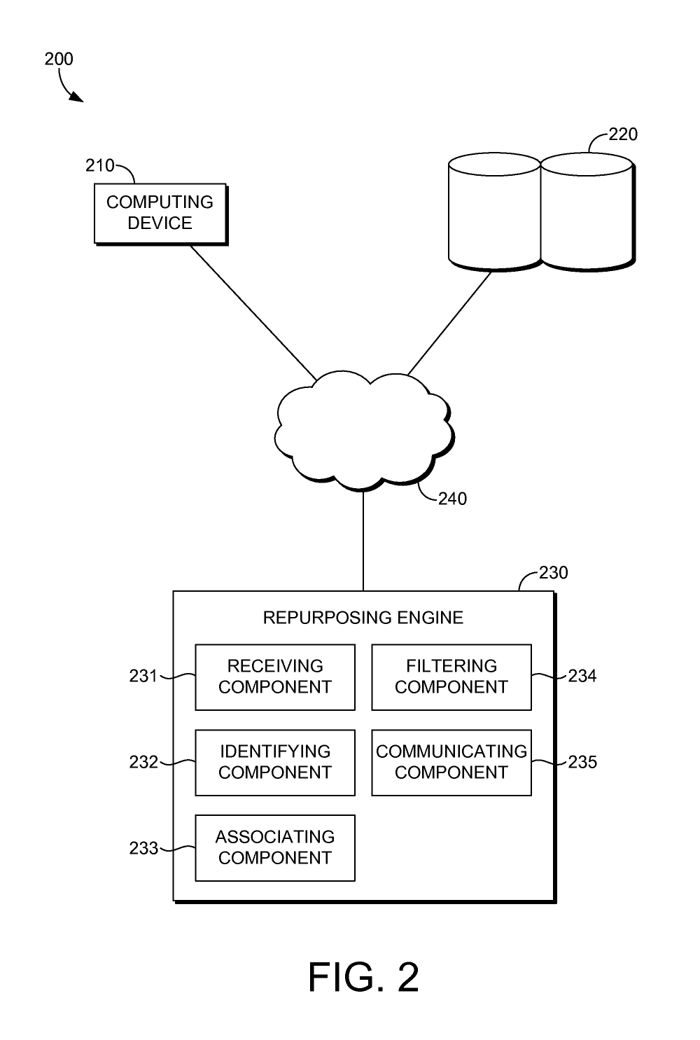

As indicated previously, embodiments of the present invention are directed to repurposing an input area. In embodiments, input areas are found within a toolbar. Turning now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a personal computing device 210, a data store 220, and a repurposing engine 230. The personal computing device 210 may include any type of computing device, such as the computing device 100 described with reference to FIG. 1, for example. The repurposing engine 230 may take the form of a dedicated device for performing the functions described below, may be integrated into, e.g., the personal computing device 210, a network access device, a search engine, or the like, or any combination thereof. The components of the computing system 200 may communicate with each other via a network 240, which may include, without limitation, one or more local area networks (LANs) and/or wide area networks (WANs). Such networking environments are commonplace in offices, enterprise-wide computer networks, intranets and the Internet. It should be understood that any number of personal devices and repurposing engines may be employed in the computing system 200 within the scope of embodiments of the present invention. Each may comprise a single device/interface or multiple devices/interfaces cooperating in a distributed environment. For instance, the repurposing engine 230 may comprise multiple devices and/or modules arranged in a distributed environment that collectively provide the functionality of the repurposing engine 230 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the personal computing device 210, as an Internet-based service, or as a module inside a search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or client computing devices. By way of example only, the repurposing engine 230 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which input areas are associated with one or more applications. As will be described in further detail below, embodiments of the present invention associate input areas of toolbars with one or more applications running at the time an input is received such that the application filters actions of the input area.

The repurposing engine 230 is configured to repurpose input areas and associate the input area with one or more applications. As previously stated, a toolbar, as used herein, refers generally to a component of a graphical user interface (GUI) that includes onscreen selectable elements such as menus, buttons, icons, or other input or output elements. An input area, as used herein, refers generally to an area configured to receive an input. In embodiments, the input area is located within the toolbar. In additional embodiments, the toolbar further includes a mode indicator and one or more application-launch indicators. A mode indicator, as will be discussed in detail below, is configured to, upon selection thereof, identify a mode of an input area. An application-launch indicator, as used herein, refers generally to an indicator that is configured to, upon selection thereof, launch an application associated with the application-launch indicator. For instance, an application-launch indicator may be associated with an electronic mail (e-mail) application such that, upon selection of the application-launch indicator, the e-mail application is initiated or launched.

The repurposing engine 230 includes a receiving component 231, an identifying component 232, an associating component 233, a filtering component 234, and a communicating component 235. The receiving component 231 is configured to receive input from, for example, an input area. The input may be, for example, a search query input. The receiving component 231 is also configured to receive a selection of an application-launch indicator, a selection of a mode indicator, and the like.

The receiving component 231 may receive a variety of inputs affecting the functionality of the input area. Initially, the mode indicator may be selected such that the selection thereof is received by the receiving component 231. The mode indicator identifies a mode of the input area. Modes may include, among others, a linking mode and a non-linking mode. A linking mode, as used herein, refers generally to a mode of an input area that results in the input area being associated with, and potentially filtered by, one or more applications. In embodiments, the input area is associated with one or more applications that are currently running.

A non-linking mode, as used herein, refers generally to a mode of an input area that is not associated with a particular application. Non-linking modes result in users being presented with results that are not related to applications such as typical Internet results. In embodiments, an input received in an input area while in the non-linking mode is not filtered by any applications and the results of the input are not related to any applications.

In alternative embodiments, an application-launch indicator is selected such that an application associated with the application-launch indicator is identified and filters the results. Once an application-launch indicator is selected, a mode may be identified. In embodiments, the input area automatically enters a linking mode upon selection of the application-launch indicator such that the input area is automatically linked to the application associated with the application-launch indicator. In other embodiments, the input area only enters the linking mode upon selection of the mode indicator.

Second, receiving component 231 may receive a user input in combination with a trigger. A trigger, as used herein, refers generally to any identifier that is associated with an application. The user input, along with the trigger, is received by the receiving component 231. By way of example only, an input “@mail” may be a trigger that is associated with a mail application such that any input including “@mail” may, as described in detail below, be filtered by the mail application associated with the trigger. In additional examples, the trigger may be associated with a social networking application such that contacts of the social networking application may be searched or actions may be executed with respect to the social networking application from the user input area. For instance, the user input area could be repurposed to be a status input area to update a status on a social networking application.

Finally, the receiving component 231 may receive a user input without a trigger. A user input without a trigger may cause results typical to Internet results to be displayed. A user input without a trigger may cause results typical to Internet results to be displayed in combination with results filtered by one or more applications. In this situation, the input area may be repurposed such that any application that is running at the time the input is received is used to filter the results since no particular application was identified by, for example, a trigger. Provided that a non-linking mode selection has not been received by the receiving component 231, a user input without a trigger may yield results filtered by one or more applications running at the time of the user input.

The identifying component 232 is configured to identify information associated with or included within received inputs. In embodiments, the identifying component 232 is configured to identify a trigger associated with an input, an application associated with a trigger, an application associated with a selected application-launch indicator, a list of applications running at the time the input is received, a mode of the input area, and the like. Upon identifying a trigger, results may be filtered by the application associated with the trigger. Similarly, upon identifying a mode of the input area, results may be filtered accordingly.

Information associated with or included within received inputs may be retrieved from a database, such as the data store 220. Alternatively, the information may be retrieved once a user input is received. Such real-time generation allows for the most up-to-date information to be accessed.

The associating component 233 is configured to associate an input area with an application and/or mode. The associating component 233 may associate the input area with a linking mode, a non-linking mode, an application associated with a trigger, an application associated with an application-launch indicator, all applications running at the time a user input is received, and the like. In embodiments, the associating component 233 is configured to associate the input area with an application associated with a trigger identified within a user input. For instance, as with the above example, a user input including “@mail” would cause the associating component 233 to associate the input area with an application associated with the trigger “@mail.”

The filtering component 234 is configured to filter results based on the input area mode, any applications associated with the input area, and the like. For instance, the input area may be associated with a linking mode to a selected application such that the selected application filters the results displayed to a user. Assuming the input area is in linking mode with an e-mail application, results would be displayed to a user from the content of the e-mail application. So, if a user input “Maya” into the input area in linking mode with the e-mail application, an exemplary result may be contact information from the e-mail application that is associated with “Maya.”

The filtering component 234 may also filter results based on any applications that are running at the time the input is selected such that only results from content of running applications are displayed. Alternatively, the results filtered by the content of running applications may be displayed in combination with typical Internet results. Once filtered, if necessary, the communicating component 235 is configured to communicate results, filtered or otherwise, to the computing device 210 for presentation to a user.

In application, utilizing the exemplary system illustrated in FIG. 2, a user input is entered into the computing device 210. The user input may be a textual input in an input area and may include a trigger. Assume, for purposes of the present example, that the user input is a textual input including a trigger associated with B application. The user input is communicated to the receiving component 231 of the repurposing engine 230 via the network 240. Upon receiving the user input, the identifying component 232 then identifies the application associated with the trigger. In this case, the identifying component 232 would identify the B application as being associated with the trigger.

Once an associated application is identified by the identifying component 232, the associating component 233 associates the input area with the B application. The filtering component 234 then filters results by the content found within the B application. The communicating component 235 then communicates the filtered content to the computing device 210 for presentation to the user.

In other embodiments, a user input is entered into the computing device 210 without a trigger. Initially, the receiving component 231 receives the user input. The identifying component 232 then identifies the user input. The identifying component 232 also identifies whether the input area is in a non-linking mode. If the input area is in a non-linking mode, the input area is not associated with an application. If the input area is not in a non-linking mode, the input area is associated with one or more applications by the associating component 233. The one or more applications associated with the input area may be any applications running at the time the user input is received by the receiving component 231. Upon associating the input area with one or more applications, the filtering component 232 filters results based on the content of the one or more applications. The filtered results may be displayed to a user in combination with results that have not been filtered by the application, e.g., typical Internet results. The results are communicated to the computing device 210 by the communicating component 235.

In further embodiments, a selection of a mode indicator is received by the receiving component 231. The selection of a mode indicator is, sometimes, preceded by a selection of an application-launch indicator. This gives a user the option to open an application and determine whether they want the application to be linked to the input area or not.

Upon selection of the mode indicator, the identifying component 232 identifies the mode of the input area. Upon identifying the input area is in a non-linking mode, the input area is not associated with any applications and typical Internet results are provided. Upon identifying that the input area is in a linking mode, the associating component 233 associates the input area with an application. The linking mode typically results in the input area being associated with an application associated with an application-launch indicator selected prior to the selection of the mode indicator. As with the previous examples, once the input area is associated with an application, the filtering component 234 filters the results by the content of the application and the results are communicated to the computing device 210 by the communicating component 235.

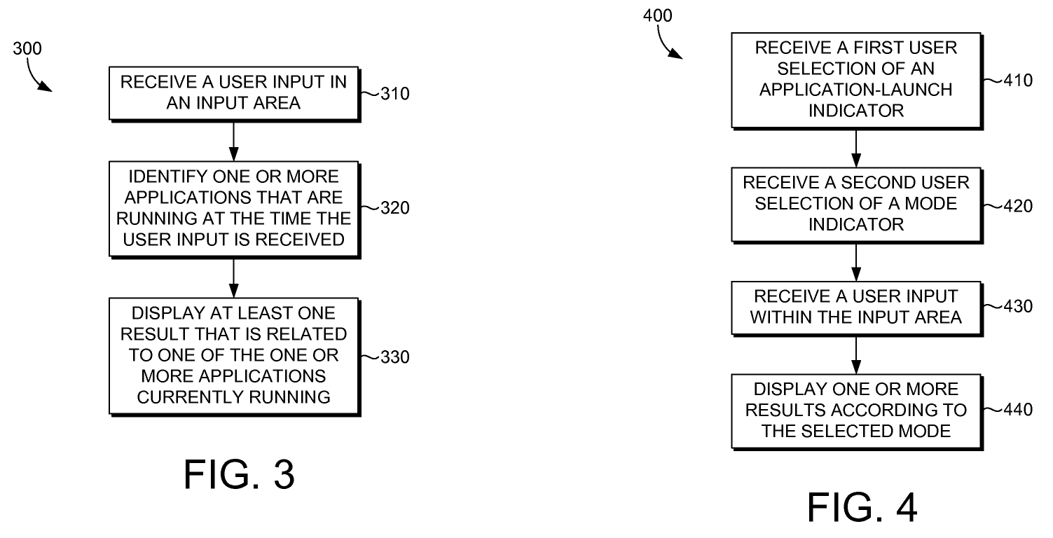

Turning now to FIG. 3, a flow diagram is provided that illustrates a first exemplary method 300 for repurposing toolbar input areas, in accordance with an embodiment of the present invention. Initially, at block 310, a user input is received in an input area. At block 320, one or more applications that are running at the time the user input is received are identified. At block 330, at least one result that is related to one of the one or more applications currently running is identified.

With reference to FIG. 4, a flow diagram is provided that illustrates a second exemplary method 400 for repurposing toolbar input areas, in accordance with an embodiment of the present invention. Initially, at block 410, a first user selection of an application-launch indicator is received. A second user selection of a mode indicator is received at block 420 and a user input is received within an input area at block 430. One or more results are displayed according to the selected mode at block 440.

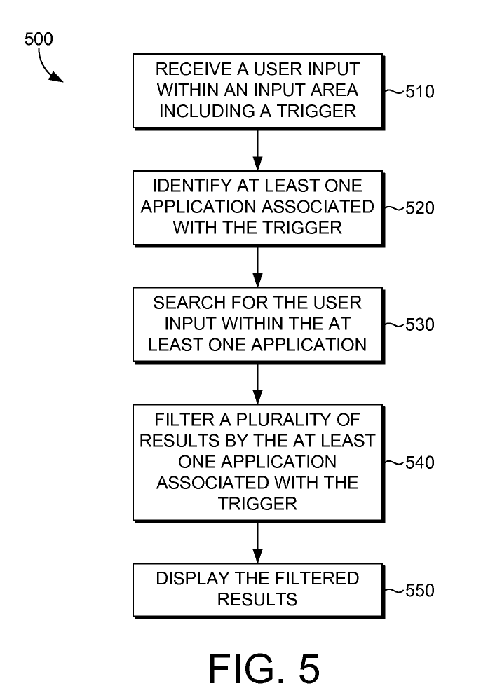

Turning now to FIG. 5, a flow diagram is provided that illustrates a third exemplary method 500 for repurposing toolbar input areas, in accordance with an embodiment of the present invention. As indicated at block 510, a user input including a trigger is received. At block 520, at least one application associated with the trigger is identified. The user input is searched for within the at least one application at block 530. A plurality of results is filtered by the at least one application at block 540. The filtered results presented at block 550.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3, 400 of FIG. 4 and the method 500 of FIG. 5 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method, the method comprising:
receiving a user input in an input area;
identifying one or more applications that are running at the time the user input is received; and
displaying at least one result that is related to one of the one or more applications currently running.

2. The one or more computer-readable storage media of claim 1, wherein the user input includes a trigger.

3. The one or more computer-readable storage media of claim 2, wherein the trigger is associated with at least one application.

4. The one or more computer-readable storage media of claim 3, further comprising:
identifying the application associated with the trigger; and
searching for the user input within the application associated with the trigger.

5. The one or more computer-storage media of claim 4, further comprising displaying only results that are located within the application associated with the trigger.

6. The one or more computer-storage media of claim 1, further comprising searching for the user input within the one or more applications that are running at the time the user input is received.

7. The one or more computer-storage media of claim 1, further comprising displaying the at least one result that is related to one of the one or more applications currently running in combination with at least one result that is not related to the one or more applications currently running.

8. The one or more computer-storage media of claim 1, further comprising identifying a user profile.

9. The one or more computer-storage media of claim 1, wherein the one or more applications includes a social networking application.

10. One or more computer-readable storage media storing computer-useable instructions that, when used by one or more computing devices, cause the one or more computing devices to perform a method, the method comprising:
receiving a first user selection of an application-launch indicator that launches an application;
receiving a second user selection of a mode indicator, wherein the mode is one of a first mode that links an input area with the application or a second mode that separates the application and the input area;
receiving a user input within the input area; and
displaying one or more results according to the selected mode.

11. The one or more computer-storage media of claim 10, wherein the application-launch indicator and the input area are located in proximity to one another within a single toolbar.

12. The one or more computer-storage media of claim 10, wherein the first mode is selected such that the input area and the application are linked.

13. The one or more computer-storage media of claim 12, wherein linking the input area and the application results in filtering the one or more results by content available within the application.

14. The one or more computer-storage media of claim 10, wherein the results displayed for the first mode include one or more first results that are filtered by the application.

15. The one or more computer-storage media of claim 10, wherein the results displayed for the second mode include one or more second results that are not filtered by the application.

16. The one or more computer-storage media of claim 10, further comprising:
upon receiving a selection of the first mode, linking the input area with any application that is running at the time the selection of the first mode is received.

17. One or more computer-readable storage media storing computer-useable instructions that, when used by one or more computing devices, cause the one or more computing devices to perform a method, the method comprising:
receiving a user input within an input area, wherein the user input includes a trigger associated with at least one application;
identifying the at least one application associated with the trigger;
searching for the user input within the at least one application associated with the trigger;
filtering a plurality of results by the at least one application associated with the trigger; and
displaying the filtered results.

18. The one or more computer-storage media of claim 17, wherein the at least one result is further filtered by a user profile.

19. The one or more computer-storage media of claim 17, wherein the at least one application is a social networking application.

20. The one or more computer-storage media of claim 17, further comprising receiving an input within the input area to execute a task within the at least one application.
